(19) United States
(12) Patent Application Publication
(10) Pub. No.: US 2010/0233063 A1
(43) Pub. Date: Sep. 16, 2010

(54) METHOD FOR MANUFACTURING HIGH-PURITY SILICON MATERIAL

(75) Inventor: Hsien-Chung Chou, Taipei (TW)

Correspondence Address: ROGER H. CHU, 19499 ERIC DRIVE, SARATOGA, CA, 95070, US

(73) Assignee: Radiant Technology Co., Jhonghe (TW)

(21) Appl. No.: 12/615,323

(22) Filed: Nov. 10, 2009

(30) Foreign Application Priority Data
Mar. 13, 2009 (TW) 098108277

(51) Int. Cl. C01B 33/037

(52) U.S. Cl. 423/350

(57) ABSTRACT

The present invention discloses a method for manufacturing a silicon material with high purity, and the method comprises the following steps of: selecting high purity quartz as a raw material; cleaning and comminuting the quartz; choosing the particle size of the quartz between 20 mm and 80 mm by an optical analyzer; purifying the quartz; melting the quartz in a metallurgical furnace; proceeding carbothermal reduction and post-refining to the quartz so as to obtain liquid silicon; draining the liquid silicon into a ladle through a tap hole of the metallurgical furnace; removing impurities of the liquid silicon in the ladle by Moist reduction Gas Blowing and Slag Treating; pouring the liquid silicon into a casting area of a crystal growth furnace; proceeding Directional Solidification to the liquid silicon in the casting area so as to obtain a solid silicon material.

### BACKGROUND OF THE INVENTION

1. Technical Field

The present invention relates to methods for manufacturing a silicon material and, more particularly, to a method for manufacturing a high-purity silicon material.

2. Description of Related Art

Silicon is one of the most important materials for semiconductors in the electronic industry. Currently, Si-based elements account for 95% of the global sales of semiconductor elements. Silicon makes up approximately 28% of the Earth's crust and is the second most abundant element in the crust, after oxygen. Besides, it processes excellent mechanical properties and contains innate dielectric, namely SiO₂. In the nature, Silicon never occurs as the pure free element in nature but usually exists in the forms of silica (impure SiO₂) and silicate. Silicon has a moderate energy gap of 1.1 eV, and Si-based elements are workable below 150° C. SiO₂ is insoluble in water, and is applicable in the planar technology to fabricate transistors or integrated circuits. Our civilization nowadays is, so to speak, the Silicon age.

MG-Si (Metallurgical-Grade Si), one of the constituent materials of which solar batteries are made, is of three types, namely monocrystalline Si, polycrystalline Si and non-crystalline Si. Monocrystalline Si and polycrystalline Si are mainly refined from high-purity quartz sand (>97%), which is also in the form of SiO₂ crystals. The first step of producing high-purity polycrystalline Si is to extract Si from the silica sand. To extract Si by reduction of SiO₂, raw materials, such as silica sand, coke, coal and wood, are mixed and placed in an electric arc furnace with graphite electrodes to be heated at temperature between 1500 and 2000° C., so as to realize chemical reactions as follows:

SiO₂+C →Si+CO₂

SiO₂+2C→Si+2CO

The product, silicon, has a purity of about 98%, known as MG-Si, which requires further purification for applications in solar batteries or semiconductor products.

However, the aforesaid traditional MG-Si process is plagued with its byproduct, that is, gaseous CO₂, that brings toxic substances at high temperature and is suspected to damage human cranial nerves, not to mention the fact that CO₂ is detrimental to the atmosphere. Therefore, it is desired to have a novel technology that prepares MG-Si with less chemical involvement and less production of CO₂.

MG-Si may be further refined to obtain EG-Si (Electronic-Grade Si), which refers to polycrystalline Si having a silicon purity of 99.9999%, or greater than 6N, and having an impurity level below 1 ppm. For producing polycrystalline Si, Siemens process, as the most reputed approach, includes three main steps:

Step 1: Si+3HCl→HSiCl₃+H₂

Chlorination is performed to obtain TCS (Trichlorosilane, HSiCl₃). Therein, MG-Si reacts with HCl in the presence of CuCl that acts as a catalyst in a fluidized bed reactor so as to get TCS that comes along with other silicon chlorides, such as SiH₂Cl₂ or SiCl₄.

Step 2: HSiCl₃(Purity>98%)→HSiCl₃(Purity>6N)

Distillation for producing high-purity TCS needs at least two distillation towers.

Step 3: HSiCl₃+H₂→Si+3HCl

The decomposition is conducted by introducing TCS into a pyrolysis furnace. In the presence of hydrogen, TCS is decomposed and thus silicon deposits onto a U-shaped Silicon ingot in the pyrolysis furnace. To reach the deposition temperature of TCS, namely 1100° C., electrodes are implemented to allow the internal temperature of the U-shaped Silicon ingot to be 1500° C. Meanwhile, to prevent TCS from being deposited on walls of the pyrolysis furnace that may otherwise hinder operation, a large amount of cooling water has to be provided outside the walls of the pyrolysis furnace.

The traditional Siemens process that refines polycrystalline Si by means of chlorination has the following features: (1) it is a mature reliable technology for producing silicon that meets semiconductor grading standards; (2) high Si-TCS conversion efficiency; and (3) chlorination can take place at relatively low temperature and pressure. Thus, Siemens process is extensively used by the majority of global manufacturers (more than 75%) to produce polycrystalline Si. However, it also has its defects, including: (1) consuming power greatly and requiring manufacturers' competence in obtaining and processing HCl; (2) forming a byproduct in chlorination, that is, SiCl₄ which is highly contaminating, toxic, difficult to dispose of, and unfriendly to local environments; (3) periling the operators; (4) requiring complex operation; and (5) demanding a considerable license fee.

In view of the above defects, many technologies have been developed in attempts to improve the traditional Siemens process. An improved Siemens process, for example, involves replacing chlorination with hydrochlorination in Step 1 so as to obtain Silicon Chloride (that may be otherwise purchased). Then, through the hydrochlorination, MG-Si reacts with Silicon Chloride in the presence of hydrogen to form TCS, along the path of the following chemical equation:

Si+SiCl₄→2 HSiCl₃

Then, the same distillation and deposition as those provided by the traditional Siemens process that implements chlorination are conducted. The improved Siemens process that implements hydrochlorination features has the following advantages: (1) reduced manufacturing costs; and (2) reduced power consumption as compared with the traditional Siemens process. Nevertheless, a drawback of the improved Siemens process is that hydrochlorination has to take place at relatively high temperature and pressure, implying the risk of explosion, and lower first Si-TCS conversion efficiency.

Taking the traditional Siemens process as example again, for refining and thus obtaining EG-Si, Step 3 involves decomposing TCS at high temperature so as for silicon to deposit on the Silicon ingot, and this procedure is known as crystal growth. After continuous researches and development, many methods and crystal growth plants have been introduced, among which, Czochralski pulling method and Czochralski crystal grower are extensive applied in the industry. Czochralski pulling method involves placing and melting Si-based material in a crucible, and pulling up an ingot with a puller gradually under the guide of seeds, so as to form a solid-liquid interface. Therein, the larger the ingot is, the slower the pulling rate is. Generally, an ingot for 8-inch wafers requires about 1-2 days. During growth, impurity atoms tend toward the liquid phase on the ingot. Consequently, most impurities are expelled to the liquid phase and thus stay at the distal portion of the ingot so as to be easily cut off and disposed of. Through such zone refining process, the purity of the silicon ingot is improved. However, Czochralski pulling method is disadvantaged by being time-consuming and power-consuming in crystal growing, and thus not perfect in efficiency.

Hence, it is desired to have a novel technology whereby polycrystalline Si is produced with less chemical involvement by a low-contamination process, and it is desired to have a novel crystal-pulling method that enables crystal growth to be time-saving and power-saving, thereby overcoming the shortcomings of the prior art.

### SUMMARY OF THE INVENTION

In view of the needs, with his imagination, creativity and years of experience, and by repeated trials and modifications, the inventor invents and discloses herein a method for manufacturing a high-purity silicon material.

An objective of the present invention is to provide a method for manufacturing a high-purity silicon material, wherein the method implements a carbothermal reduction method to turn silica into silicon by reduction. The carbothermal reduction method uses a specially formulated pure-carbon reducing agent in place of the traditionally used coal tar or coking coal that contains a high level of heavy metal. The carbothermal reduction method also uses a specially formulated cellulose material and other organic carbon materials in place of the traditionally used wood flour, so as to improve the conventional method by remedying the problems related to pollution, power consumption and danger.

Another objective of the present invention is to provide a method for manufacturing a high-purity silicon material, wherein the method takes creative flow paths and equipment and less than 36 hours to complete the whole process from silica reduction to crystal growth, thereby facilitating saving power and improving production of polycrystalline Si significantly, as compared with the traditional methods that usually take more than 46 hours to complete the same whole process.

Still another objective of the present invention is to provide a method for manufacturing a high-purity silicon material, wherein the method involves comminuting silicon sand that initially has a small particle size and a high purity into the high-purity silicon particles with nanoscale dimensions. The traditionally used silica particles having relatively large size tend to contain impurities and are difficult to purify, whereas the method of the present invention makes silica purification easier and improves the purity of the silica material.

Yet another objective of the present invention is to provide a method for manufacturing a high-purity silicon material, wherein the method implements a purification procedure to purify quartz sand before put the same into reduction. The purification procedure features for a unique acid-scrubbing process that effectively removes impurities so as to make silica purification easier and improve the purity of the silica material.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a flowchart illustrating a method for manufacturing a high-purity silicon material according to one embodiment of the present invention;

FIG. 2 is a flowchart illustrating a purification process for quartz ores according to the embodiment of the present invention;

FIG. 3 is a schematic drawing showing fissures on a quartz ore;

FIG. 4 is a structural drawing of a metallurgical furnace according to the embodiment of the present invention; and

FIG. 5 is a graph of free energy against temperature during reaction between silica and carbon.

### DETAILED DESCRIPTION OF THE PREFERRED EMBODIMENTS

To achieve the objectives and functions of the present invention, the inventor, after repeated modifications and adjustments, has brought improvements to the conventional technologies in selection of material and efficiency of reduction as well as purification and thus provides a method for manufacturing a high-purity silicon material. Hereinafter, one embodiment of the disclosed method will be described in detail in order to illustrate the technical characters and the method of the disclosure.

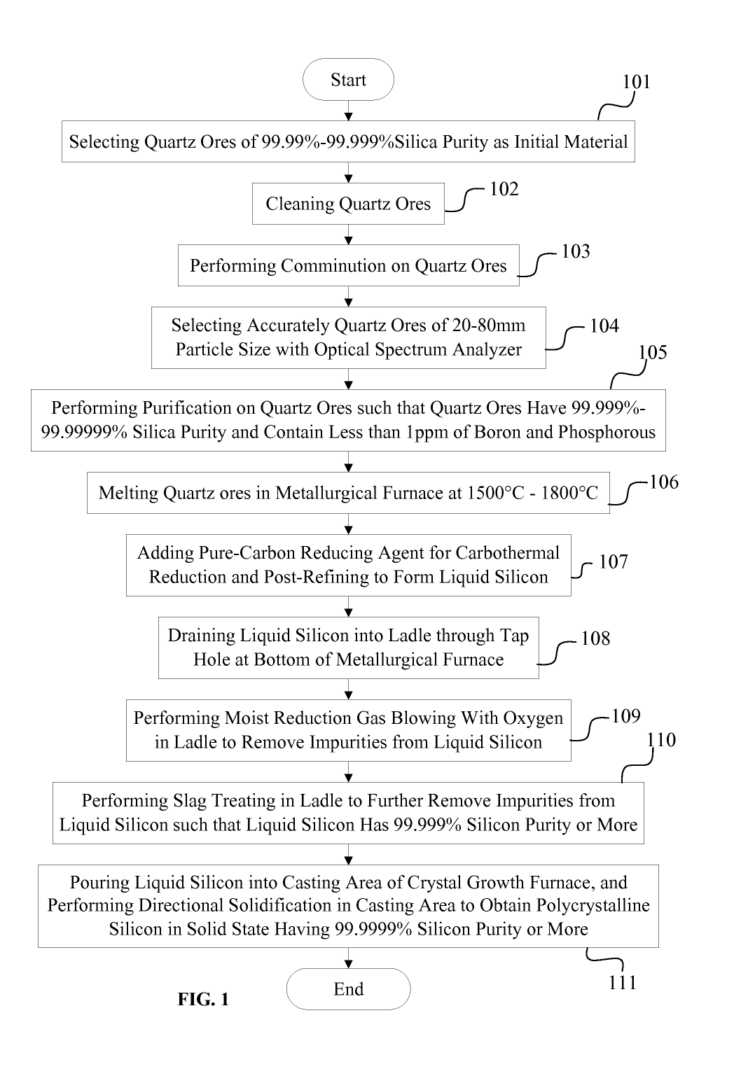

Please refer to FIG. 1 for the method for manufacturing the high-purity silicon material according to the present invention. The method comprises the following steps:

(1) selecting pure quartz ores whose silica purity ranging between 99.99% and 99.999% as an initial material (Step 101), wherein the quartz ores are in the form of quartz sand and the selected initial material has the purity 100-fold higher than that of the traditionally used quartz ores;

(2) cleaning the selected quartz ores (Step 102);

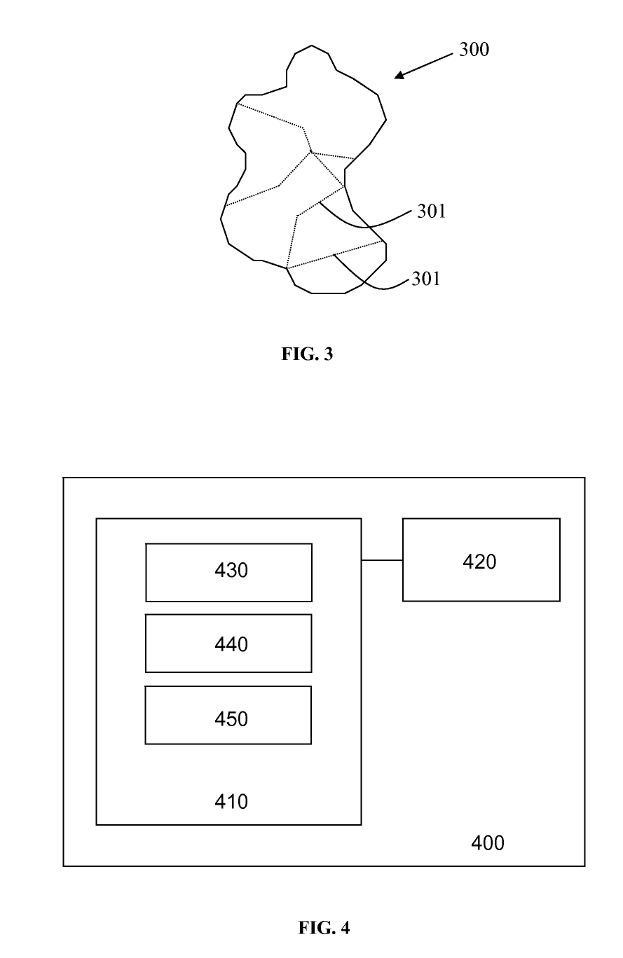

(3) performing contamination-free comminution on the quartz ores at fissures on the quartz ores (Step 103), wherein the fissures are fissures 301 (shown in FIG. 3) on a quartz ore 300;

(4) selecting quartz ores of a particle size ranging between 20 mm and 80 mm with an optical spectrum analyzer (Step 104), wherein the quartz ores selected in the present step ought to be white or ivory in color;

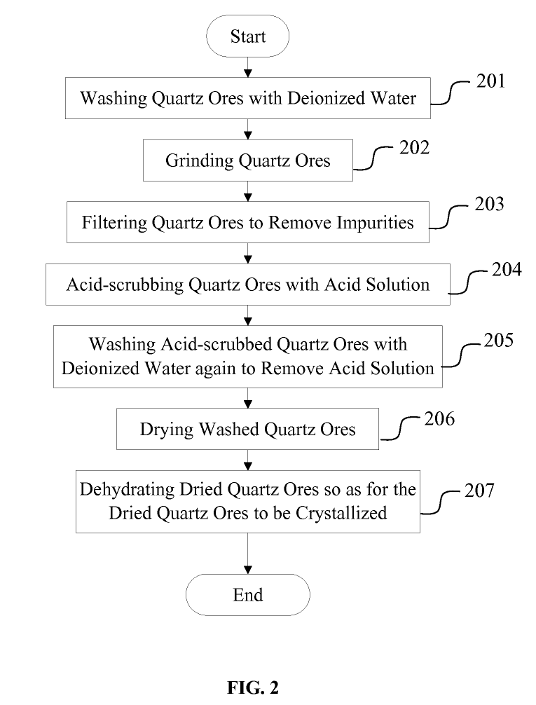

(5) performing purification on the later-selected quartz ores such that the purity of the quartz ores becomes 99.999% to 99.99999% of silica while containing less than 1 ppm of boron and phosphorous (Step 105), wherein the purification, referring to FIG. 2, further comprises the following steps:
(5.1) washing the quartz ores with deionized water so as to preliminarily filter impurities (Step 201);
(5.2) grinding the quartz ores (Step 202);
(5.3) filtering the quartz ores to further remove impurities (Step 203);
(5.4) acid-scrubbing the quartz ores with an acid solution (Step 204), wherein the acid solution is one of sulfuric acid, a mixture of ammonium hydroxide and ethylene diamine tetraacetic acid, an acid peroxide mixture, and dimethyl fumarate;
(5.5) washing the acid-scrubbed quartz ores with deionized water again to remove the acid solution (Step 205);
(5.6) drying the washed quartz ores (Step 206); and
(5.7) dehydrating the dried quartz ores so as for the dried quartz ores to be crystalized (Step 207);

(6) placing the purified quartz ores in a metallurgical furnace 400 (shown in FIG. 4) that is composed of a SAF (Submerged Arc Furnace) 410 and a filter 420, in which the SAF further includes a crucible 430, an electrode rod 440 and a tap hole 450 so that when a high current passes the electrode rod 440, an electric arc is formed between the electrode rod 440 and a surface of the crucible 430 so as to present a temperature as high as 1500 to 1800° C. that melts the quartz ores (Step 106), wherein, the metallurgical furnace features for: (a) providing high-frequency temperature control; (b) having the tap hole provided at a bottom of the metallurgical furnace so that products of reaction can be easily drained through the tap hole; (c) being applicable to melting various metals; and (d) having an operational temperature up to 1800° C.;

(7) adding a pure-carbon reducing agent, a cellulose-based material and an organic carbon-based material for carbothermal reduction and post-refining, wherein the melted quartz ores reacts with the pure-carbon reducing agent to form liquid Si (Step 107), the pure-carbon reducing agent preferably containing Gas black in gaseity because the pure-carbon reducing agent presents a higher purity of carbon in gaseity than in the solid state and thus facilitates maximizing silicon reduction efficiency and improving the purity of the Si product, the aforementioned carbothermal reduction and post-refining further involving:
(7.1) the melted silicon ores reacting with carbon to form silicon monoxide;
(7.2) silicon monoxide further reacting with carbon to form carborundum in a solid state; and
(7.3) carborundum reacting with the melted silicon ores to form liquid Si and silicon monoxide, wherein the formed silicon monoxide returns to Step 7.2 to realize a cyclic reaction, wherein the above steps may be expressed by the following chemical equation:

SiO₂+2C→Si+2CO+SiO

where the produced carbon monoxide is fully discharged through the cellulose-based material and the organic carbon-based material, while part of the formed silicon monoxide discontinulously reacts with carbon and further reacts with oxygen to form high-purity silica (having a purity level of above 99.99999%), and the high-purity silica is then filtered by the filter so as for the filtered high-purity silica to be collected as a byproduct, wherein the step is expressed by the chemical equation below:

2SiO+O₂→2SiO₂;

(8) draining the liquid Si into an ladle through the tap hole at the bottom of the metallurgical furnace (Step 108);

(9) performing moist reduction gas blowing in the ladle with oxygen so as to remove impurities from the liquid Si (Step 109);

(10) performing slag treating in the ladle to further remove impurities from the liquid Si and increase the purity of silicon to above 99.999% (Step 110), wherein the resultant Si is referred to as XMG-Si; and

(11) pouring the liquid Si into a casting area of a crystal growth furnace, and performing directional solidification in the casting area to obtain polycrystalline Si in a solid state and having a purity level of above 99.9999% (Step 111), that is referred to as SoG-Si, wherein the crystal growth furnace features (a) high efficiency and a short melting cycle; (b) ease of operation and maintenance, as material feeding and product outputting are carried out at the bottom of the crystal grower; (c) automatic temperature control for segmented stepped vertical heating and cooling; and (d) being programable to cater for melting of various materials.

To optimize the above-disclosed method, the conditions and parameters of each of the steps may be adjusted and the steps of the method can be rewritten as:

(1) selecting pure quartz ores whose silica purity is of 99.999% as an initial material, wherein the quartz ores are in the form of quartz sand;

(2) cleaning the selected quartz ores;

(3) performing contamination-free comminution on the quartz ores at fissures on the quartz ores;

(4) selecting accurately quartz ores of a particle size of 50 mm with an optical spectrum analyzer, wherein the quartz ores selected in the present step ought to be white or ivory in color;

(5) performing purification on the later-selected quartz ores such that the purity of the quartz ores becomes 99.99999% of silica while containing less than 0.5 ppm of boron and phosphorous, wherein the purification further comprises the following steps:

(5.1) washing the quartz ores with deionized water so as to preliminarily filter out impurities;

(5.2) grinding the quartz ores;

(5.3) filtering the quartz ores to further remove impurities;

(5.4) acid-scrubbing the quartz ores with an acid solution, wherein the acid solution is sulfuric acid;

(5.5) washing the acid-scrubbed quartz ores with deionized water again to remove the acid solution;

(5.6) drying the washed quartz ores; and

(5.7) dehydrating the dried quartz ores so as for the dried quartz ores to be crystallized;

(6) placing the purified quartz ores in a metallurgical furnace to melt the quartz ores at a high temperature of 1650° C.;

(7) adding a pure-carbon reducing agent, a cellulose-based material and an organic carbon-based material for carbothermal reduction and post-refining, wherein the melted quartz ores reacts with the pure-carbon reducing agent to form liquid Si, the aforementioned carbothermal reduction and post-refining further involving:

(7.1) the melted silicon ores reacting with carbon to form silicon monoxide;

(7.2) silicon monoxide further reacting with carbon to form carborundum in a solid state; and

(7.3) carborundum reacting with the melted silicon ores to form liquid Si and silicon monoxide, wherein the formed silicon monoxide returns to Step 7.2 to realize a cyclic reaction,

wherein the above steps may be expressed as the following chemical equation:

SiO₂+2C→Si+2CO+SiO

where the produced carbon monoxide is fully discharged through the cellulose-based material and the organic carbon-based material, while part of the formed silicon monoxide discontinulously reacts with carbon and further reacts with oxygen to form high-purity silica (having a purity level of above 99.99999%), and the high-purity silica is then filtered by the filter so as for the filtered high-purity silica to be collected as a byproduct, wherein the step is expressed by the chemical equation below:

2SiO+O₂→2SiO₂;

(8) draining the liquid Si into an ladle through the tap hole at the bottom of the metallurgical furnace;

(9) performing moist reduction gas blowing in the ladle with oxygen so as to remove impurities from the liquid Si;

(10) performing slag treating in the ladle to further remove impurities from the liquid Si and increase the purity of silicon to above 99.999% (Step 110), wherein the resultant Si is referred to as XMG-Si; and

(11) pouring the liquid Si into a casting area of a crystal growth furnace, and performing directional solidification in the casting area to obtain polycrystalline Si in a solid state and having a purity level of above 99.9999%, that is referred to as SoG-Si.

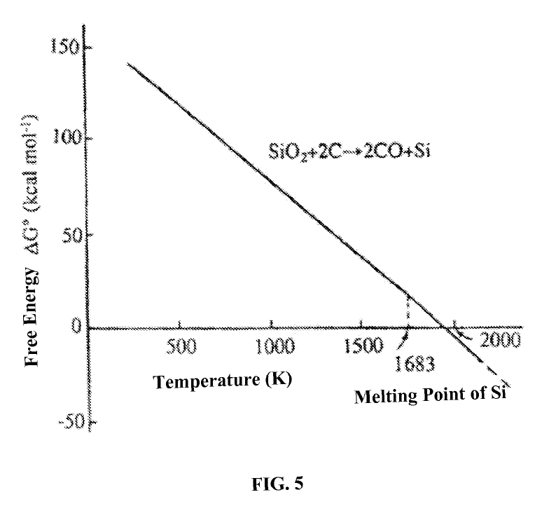

FIG. 5 is a graph of free energy against temperature during reaction between silica and carbon. The free energy ΔG is an important index for a chemical reaction. Free energy ΔG<0 means that energy released in the chemical reaction is sufficient to overcome environmental resistance and thus the reaction is led forward to its product, indicating that this is a spontaneous reaction. Free energy ΔG>0 means that energy released in the chemical reaction is insufficient to overcome environmental resistance and thus the reaction is not spontaneous. Meanwhile, the free energy ΔG of the reverse reaction is less than zero, so the reaction proceeds reversely. Free energy ΔG=0 means that the reaction is now balanced and the reaction in positive direction and reverse direction have equal driving force. As shown in FIG. 5, the melting point of silicon is 1683° C. while the temperature range where the free energy of the reaction between silica and carbon ΔG=0 is between 1683° C. and 2000° C. Therefore, in the present embodiment, the temperature from 1500° C. to 1800° C. recited in Step (6) for melting the quartz ores and allowing reduction to occur is determined according to the desired free energy ΔG.

With the method of the present invention, effective production of high-purity polycrystalline Si is ensured, and the resultant silicon material is applicable to semiconductor industry and photovoltaic industry and thus has great industrial applicability. Compared with the traditional Siemens process and Czochralski pulling method, the method of the present invention is more manageable and more economical, and thus has remarkable development potential. To sum up, the method of the present invention has the following advantages:

The method implements carbothermal reduction to turn silica into Si, and the carbothermal reduction relates to the specially formulated pure-carbon reducing agent but not the traditionally used coal tar or coking coal that contains a high level of heavy metal. Besides, the carbothermal reduction disclosed in the present invention also uses the specially formulated cellulose-based and organic carbon-based materials in place of the traditionally used wood flour. As a result, the method of the present invention remedies the defects of the conventional approaches, such as causing pollution, consuming considerable power, and incurring danger.

The method of the present invention takes no more than 36 hours to complete the whole process from silica reduction to crystal growth. As compared with the traditional methods taking more than 46 hours, the present invention facilitates saving power and improving production of polycrystalline Si significantly.

The method of the present invention uses silicon sand that initially has small particle size and high purity, thereby making silica purification easier and improving the purity of the silica material.

The method, during purification, uses the acid-scrubbing process to remove impurities. Since the acid-scrubbing process only requires a small amount of chemical materials, the method lessens chemical pollution and facilitates environmental protection.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for manufacturing a high-purity silicon material, comprising steps of:
(1) selecting pure quartz ores as an initial material, wherein the quartz ores have a first purity of silica;
(2) cleaning the selected quartz ores;
(3) performing comminution on the quartz ores;
(4) selecting accurately the quartz ores of a predetermined particle size with an optical spectrum analyzer;
(5) performing purification on the quartz ores such that the quartz ores have a second purity of silica and contain a specific level of boron and phosphorous;
(6) placing the quartz ores in a metallurgical furnace and heating the quartz ores therein to a predetermined high temperature to melt the quartz ores;
(7) adding a pure-carbon reducing agent for carbothermal reduction and post-refining, wherein the melted quartz ores react with the pure-carbon reducing agent to form liquid silicon;
(8) draining the liquid silicon into a ladle through a tap hole of the metallurgical furnace;
(9) performing moist reduction gas blowing in the ladle with oxygen so as to remove impurities from the liquid silicon;
(10) performing slag treating in the ladle to further remove impurities from the liquid silicon and allow the liquid silicon to have a third purity of silicon; and
(11) pouring the liquid silicon into a casting area of a crystal growth furnace, and performing directional solidification in the casting area to obtain polycrystalline silicon that is in a solid state and has a fourth purity of silicon.

2. The method of claim 1, wherein the first purity in Step (1) ranges between 99.99% and 99. 999%.

3. The method of claim 1, wherein the quartz ores in Step (1) are in the form of quartz sand.

4. The method of claim 1, wherein the predetermined particle size in Step (4) ranges between 20 mm and 80 mm.

5. The method of claim 1, wherein the quartz ores of the predetermined particle size in Step (4) ought to be white or ivory in color.

6. The method of claim 1, wherein the purification in Step (5) further comprises:
(5.1) washing the quartz ores with deionized water;
(5.2) grinding the quartz ores;
(5.3) filtering the quartz ores to remove impurities;
(5.4) acid-scrubbing the quartz ores with an acid solution;
(5.5) washing the acid-scrubbed quartz ores with deionized water again to remove the acid solution;
(5.6) drying the washed quartz ores; and
(5.7) dehydrating the dried quartz ores so as for the dried quartz ores to be crystallized.

7. The method of claim 6, wherein the acid solution in Step (5.4) is one of sulfuric acid, a mixture of ammonium hydroxide and ethylene diamine tetraacetic acid, an acid peroxide mixture, and dimethyl fumarate.

8. The method of claim 1, wherein the second purity in Step (5) ranges between 99.999% and 99.99999%.

9. The method of claim 1, wherein the predetermined amount in Step (5) is less than 1 ppm.

10. The method of claim 1, wherein the metallurgical furnace in Step (6) comprises a SAF (Submerged Arc Furnace) and a filter, the SAF further including at least one crucible, at least one electrode rod and at least one gate.

11. The method of claim 1, wherein the predetermined high temperature in Step (6) ranges between 1500° C. and 1800° C.

12. The method of claim 1, wherein the pure-carbon reducing agent in Step (7) contains gas black in gaseity.

13. The method of claim 1, wherein a cellulose-based material and an organic carbon-based material are used in Step (7) for carbothermal reduction and post-refining.

14. The method of claim 1, wherein the third purity in Step (10) is greater than 99.999%.

15. The method of claim 1, wherein the fourth purity in Step (11) is greater than 99. 9999%.
